(19) United States
(12) Patent Application Publication
(10) Pub. No.: US 2024/0389791 A1
(43) Pub. Date: Nov. 28, 2024

(54) COOKING CONTROL SYSTEM

(71) Applicant: WHIRLPOOL CORPORATION, BENTON HARBOR, MI (US)

(72) Inventors: Andrea Gallivanoni, Varese (IT); Alan Phong Nguyen, St. Joseph, MI (US); Annalisa Pacioni, Milan (IT)

(73) Assignee: WHIRLPOOL CORPORATION, BENTON HARBOR, MI (US)

(21) Appl. No.: 18/671,359

(22) Filed: May 22, 2024

Related U.S. Application Data
(60) Provisional application No. 63/468,389, filed on May 23, 2023.

(51) Int. Cl. A47J 36/32; A47J 36/24

(52) U.S. Cl. CPC A47J 36/321; A47J 36/2483

(57) ABSTRACT

A system for controlling at least one cooking device includes a temperature sensing device that couples with a food item and control circuitry in communication with the temperature sensing device. The control circuitry is configured to receive temperature data corresponding to a temperature of the food item at a first time, determine a duration between the first time and a second time corresponding to the food item being at a target food temperature, determine an elapsed time for said at least one cooking device to generate a target heating temperature, compare the duration to the elapsed time, and communicate a first signal to activate said at least one cooking device based on the comparison of the duration to the elapsed time.

### CROSS-REFERENCE TO RELATED APPLICATIONS

This application claims priority to U.S. 63/468,389, filed on May 23, 2023, entitled “COOKING CONTROL SYSTEM,” the disclosure of which is hereby incorporated herein by reference in its entirety.

### BACKGROUND OF THE DISCLOSURE

The present disclosure generally relates to a cooking control system and, more particularly, to a system that controls starting times and heating operations for one or more cooking appliances based on a food item to be cooked.

### SUMMARY OF THE DISCLOSURE

According to one aspect of the present disclosure, a system for controlling at least one cooking device includes a temperature sensing device that couples with a food item and control circuitry in communication with the temperature sensing device. The control circuitry is configured to receive temperature data corresponding to a temperature of the food item at a first time, determine a duration between the first time and a second time corresponding to the food item being at a target food temperature, determine an elapsed time for said at least one cooking device to generate a target heating temperature, compare the duration to the elapsed time, and communicate a first signal to activate said at least one cooking device based on the comparison of the duration to the elapsed time.

According to another aspect of the present disclosure, a system for controlling at least one cooking device includes a temperature sensing device that couples with a food item and control circuitry in communication with the temperature sensing device. The control circuitry is configured to receive temperature data corresponding to a temperature of the food item at a first time, determine a duration between the first time and a second time corresponding to the food item being at a target food temperature, determine an elapsed time for said at least one cooking device to generate a target heating temperature, calculate a delay period between the elapsed time and the duration, determine a starting point for activating said at least one cooking device based on the delay period, delay communication of the first signal until the starting point, and communicate a first signal to activate said at least one cooking device based on the comparison of the duration to the elapsed time.

According to yet another aspect of the present disclosure, a system for controlling at least one cooking device includes a temperature sensing device that couples with a food item, a cooktop configured to the food item, an oven configured to operate a first heating element to warm the food item in a chamber of the oven, and control circuitry in communication with the temperature sensing device. The control circuitry is configured to receive a first indication of at least one quality of the food item, determine a period of a defrost cycle of the oven to thaw the food item in the chamber based on the at least one quality, communicate a first signal to activate the first heating element in the defrost cycle for the period, selectively communicate a second indication to apply the temperature sensing device to the food item when the period elapses, receive temperature data corresponding to a temperature of the food item at a first time, determine a duration between the first time and a second time corresponding to the food item being at a target food temperature, determine an elapsed time for said at least one cooking device to generate a target heating temperature, compare the duration to the elapsed time, and communicate a second signal to activate said at least one cooking device based on the comparison of the duration to the elapsed time.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic view of a system for controlling at least one cooking device according to one aspect of the present disclosure;

FIG. 2 is a block diagram of one example of a system for controlling at least one cooking device;

FIG. 3 is a process flowchart demonstrating exemplary food preparation steps for a system for controlling at least one cooking device according to one aspect of the present disclosure; and

FIG. 4 is a double-Y-axis graph demonstrating exemplary temperature data of a food item to be cooked and temperature data of a heating profile for one or more cooking devices along an X-axis of time.

The components in the figures are not necessarily to scale, emphasis instead being placed upon illustrating the principles described herein.

### DETAILED DESCRIPTION

The present illustrated embodiments reside primarily in combinations of method steps and apparatus components related to a cooking control system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

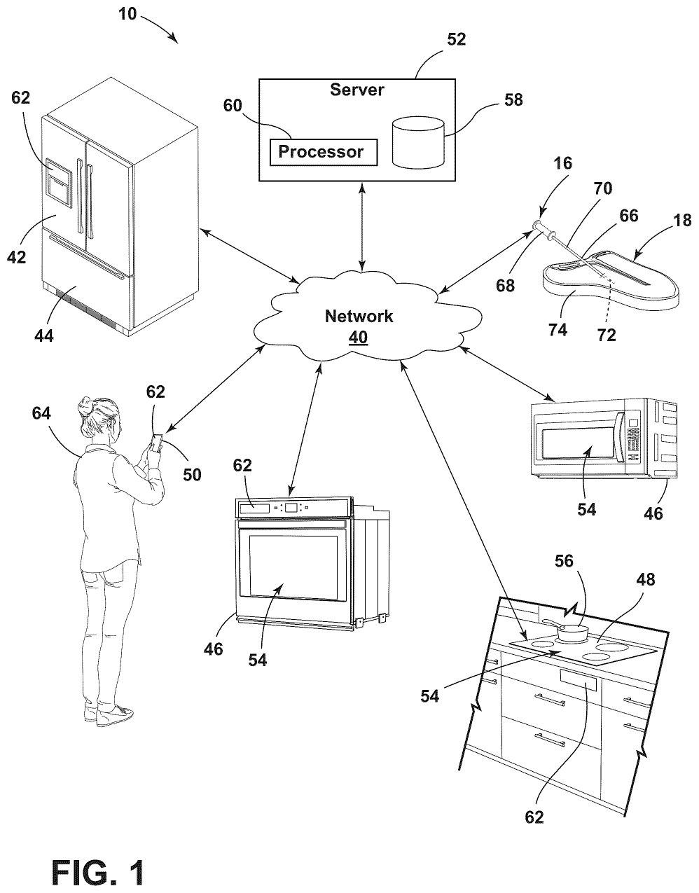

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1-4, reference numeral 10 generally designates a system for controlling at least one cooking device 12, 14. The system 10 includes a temperature sensing device 16 that couples with a food item 18. The system 10 further includes control circuitry 20 in communication with the temperature sensing device 16 and configured to receive temperature data 22 corresponding to a temperature 24 of the food item 18 at a first time 26. The control circuitry 20 is further configured to determine a duration 28, 30 between the first time 26 and a second time 32a, 32b. The second time 32a, 32b corresponds to the food item 18 being at a target food temperature 34. The control circuitry 20 is further configured to determine an elapsed time 36 for the at least one cooking device 12, 14 to generate a target heating temperature 38. The control circuitry 20 is further configured to compare the duration 28, 30 to the elapsed time 36 and communicate a signal to heat the at least one cooking device 12, 14 based on the comparison of the duration 28, 30 to the elapsed time 36.

Referring more particularly to FIG. 1, the system 10 is used to control one or more cooking devices 12, 14 for energy optimization and enhanced time management in a cooking and/or precooking scenario. By monitoring the temperature 24 of a food item 18 to be cooked and correlating thawing time, pre-cook durations, and other timing parameters, the system 10 may determine and communicate an optimal time to start a cooking phase from a pre-cooking phase (e.g., from thawing to baking) or adjust from one cooking phase to another (e.g., from searing to roasting). Further, the system 10 may determine such adjustments based on a cooking arrangement (e.g., using a single cooking device 12 or a plurality of cooking devices 12, 14) and pre-established relationships between an expected duration for food items 18 to reach a desired temperature (e.g., an optimal pre-cook temperature) depending on an initial state of the food item 18 (e.g., at room-temperature, frozen, etc.). Other pre-determined or estimated relationships include an expected pre-heating time for a given cooking device 12, 14. While primarily described in the context of optimizing pre-cook timing (e.g., energizing one or more of the cooking devices 12, 14 to temporally align with food reaching a pre-cook temperature), it is contemplated that the system 10 also employs the control circuitry 20 to adjust cooking cycle timing. Thus, the system 10 can operate dynamically amongst numerous cooking devices 12, 14 in various stages of the cooking/pre-cooking process to limit power usage and time or effort for a user of the cooking devices 12, 14.

With continued reference to FIG. 1, the system 10 provides for control and monitoring of the cooking devices 12, 14 and other appliances via a network 40, such as a wireless network 40, that is configured to provide communication amongst a plurality of appliances 42, 44, 46, 48, one or more mobile devices 50, at least one remote server 52, or any other device on the network 40. For example, the network 40 may include Wi-Fi®, Bluetooth®, ZigBee®, or any other near-or far-field communication protocols. For example, the network 40 may be part of or incorporate the Internet of Things (IoT) to allow communication between the various appliances and to provide remote control over the appliances from the one or more mobile devices 50. It is contemplated that the network 40 may also or alternatively include wired communication, such as Ethernet, Universal Serial Bus (USB), or any other wired communication protocol. For example, the plurality of appliances 42, 44, 46, 48 may communicate over Transmission Control Protocol/Internet Protocol (TCP/IP) or any of the previously described wireless or wired protocols. In some examples, the network 40 is part of a home wireless network or a commercial wireless network that allows one or more users 64 of the mobile devices 50 to control heating of the at least one cooking device 12, 14.

The plurality of appliances 42, 44, 46, 48 includes at least one storage appliance 42, 44, such as a refrigerator 42 or a freezer 44, and any number of cooking appliances 46, 48 that may be or incorporate the at least one cooking device 12, 14. The cooking appliances 46, 48 may include an oven 46, a cooktop 48, or any other cooking device that controls heat in a heating environment 54. The at least one cooking device 12, 14 may refer to a single cooking appliance or one part of a single cooking appliance (e.g., an oven 46 of a range). The oven 46 may refer to a conventional oven, a microwave oven, a convection oven having a convection fan, a range, or any device that is configured to heat a cavity of the oven 46. The cooktop 48 may refer to a griddle, a grill, a gas cooktop, an induction cooktop, or any other type of cooktop for cooking the food item 18. The cooktop 48 is configured to heat cookware 56 that holds the food item 18 and overlays the cooktop 48. The cookware 56 may include pots, pans, or other cooking vessels for cooking the food item 18.

The at least one server 52 may be configured to store and access cooking profiles for various food items, as well as access and/or store user-defined properties for cooking, such as target temperatures for food items 18, target states of the food item 18 (e.g., done, well done, rare, medium rare, etc.). For example, the server 52 may have a database 58 and a processor 60 that interacts with the database 58 to save to or load from the database 58 the cooking profiles. Via a user interface 62 on the one or more mobile devices 50 and/or the one or more cooking appliances 46, 48, a user 64 may enter desired qualities of the food item 18 and/or the cooking process, which may allow enhancement of the cooking process. For example, as will be described in further detail herein, the user 64 may select a desired cooking temperature and a desired temperature for the food item 18 when it is ready to be cooked (e.g., room temperature). In some examples, the user 64 may manually enter expected pre-heating times for one or more of the cooking devices 12, 14 at the user interface 62. Such expected pre-heating times may be saved in the database 58 and be prioritized over estimations performed by the control circuitry 20 as to pre-heating timing. For example, the particular cooking device 12, 14 may be an out-of-date model with limited specification information accessible by the server 52. Thus, the system 10 may update the expected timing based on user feedback.

Still referring to FIG. 1, the temperature sensing device 16 may include a temperature probe 66 for insertion into the food item 18. For example, the probe may include a handle 68 and a body 70 extending from the handle 68 to an end 72 that houses at least one sensor, including a thermocouple, a thermistor, a negative-temperature coefficient (NTC), a positive-temperature coefficient (PTC) thermistor, or any other suitable sensor for detecting the temperature 24 of the food item 18. For example, the temperature sensor may be configured to detect the temperature 24 of the food item 18 at a point in the vicinity of a central portion (e.g., an internal portion of the food item 18, preferably in the vicinity of its geometric center) of the food item 18. For example, the food item 18 may be a meat 74, such as beef, pork, poultry, fish, and, in general, food items 18 in which a core temperature is a key point of interest for determining end of cooking, and the temperature probe 66 may detect the temperature of the meat 74 at a central portion of the meat 74 to ensure that an accurate temperature measurement of the meat 74 is gathered by the control circuitry 20. As will be described in the proceeding figures, the control circuitry 20 may use the temperature data 22 captured by the temperature probe 66 to adjust operations of the one or more cooking devices 12, 14. More specifically, a timing 86 of the one or more heating cycles for the one or more cooking devices 12, 14 may be adjusted by the control circuitry 20 to enhance time-and energy-management for cooking operations.

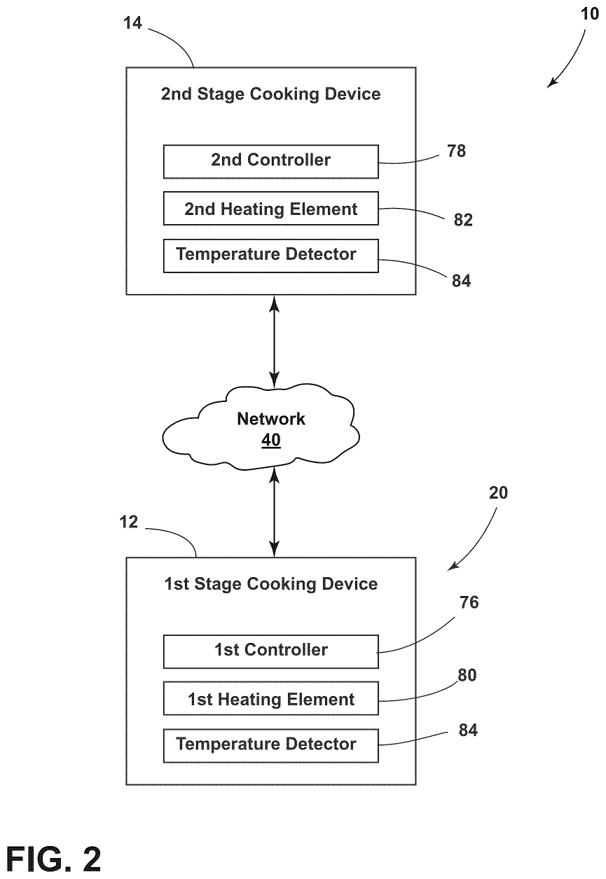

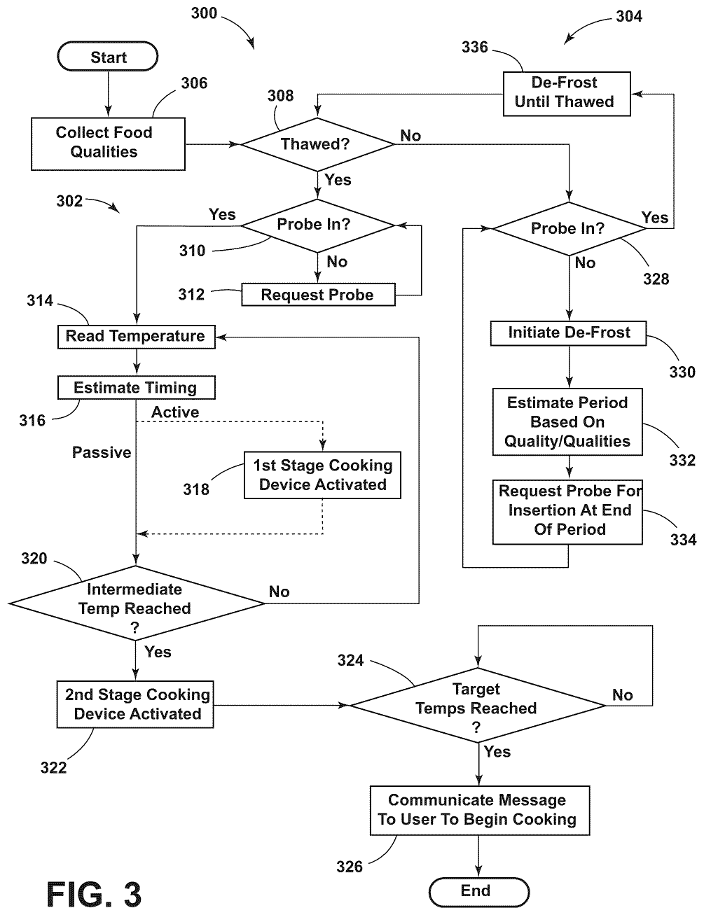

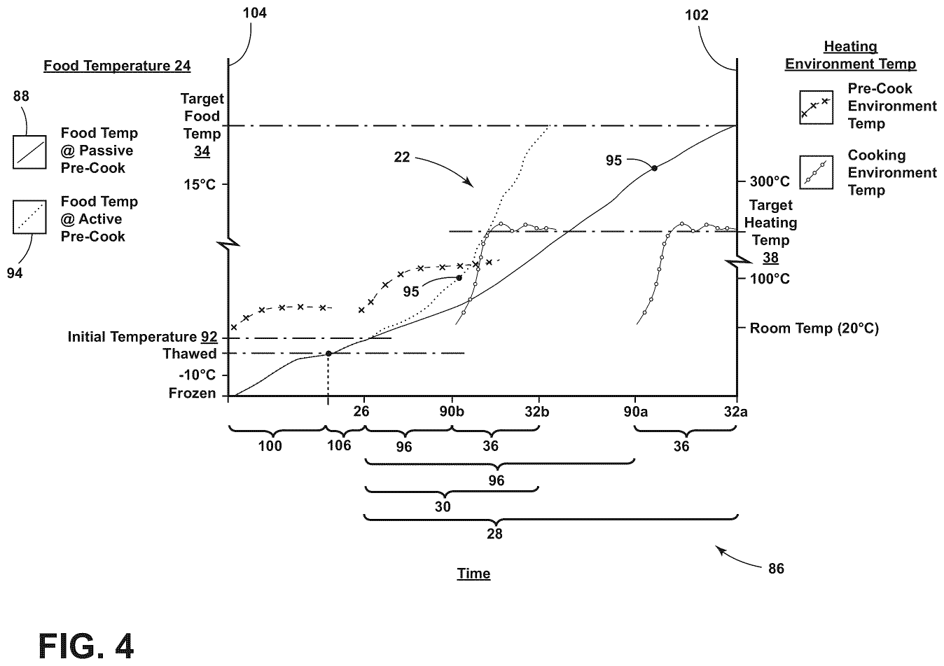

Referring now to FIG. 2-4, the at least one cooking device 12, 14 will be described with respect to the specific heating stage performed by the at least one cooking device 12, 14. For example the at least one cooking device 12, 14 includes a first stage cooking device 12 for carrying out an initial stage to warm the heating environment 54 before cooking. The at least one cooking device 12, 14 also includes a second stage cooking device 14 for carrying out a second stage to cook the food item 18. In some examples, the first stage cooking device 12 is omitted, and the present system 10 utilizes a room-temperature environment to bring the food item 18 to a desired temperature for starting the cooking process. The first and second stage cooking devices 12, 14 may include the oven 46 and the cooktop 48. In a first example, the second stage cooking device 14 is the oven 46 and the first stage cooking device 12 is omitted from use. In a second example, the second stage cooking device 14 is the cooktop 48 and the first stage cooking device 12 is omitted from use. In a third example, the first stage cooking device 12 is the oven 46 and the second stage cooking device 14 is the cooktop 48. As will be described further below with respect to FIGS. 3 and 4, the present system 10 may further be employed to carry out thawing operations using the first stage cooking device 12.

Each of the first and second stage cooking devices 12, 14 may include a controller, such as a first controller 76 for the first stage cooking device 12 and a second controller 78 for the second stage cooking device 14. The first controller 76 is in communication with at least one first heating element 80, and the second controller 78 is in communication with at least one second heating element 82. For example, the first heating element 80 may be an induction coil of the cooktop 48, and the second heating element 82 may be an electric heater configured to heat the cavity of the oven 46. The control circuitry 20 may further include other processing circuitry, such as one or more processors on the one or more mobile devices 50 and/or the processor 60 of the server 52 previously described. The control circuitry 20 may allow the user 64 to enter parameters, such as target temperatures or cooking times, at the user interface 62 on the one or more mobile devices 50, and such parameters to be communicated to the first and second controllers 76, 78 to control the first and second heating elements 80, 82, respectively. As previously described, the control circuitry 20 may also be in communication with the temperature sensing device 16 to allow for live communication and feedback from the temperature sensing device 16 and to allow the control circuitry 20 to adjust the timing 86 of heating cycles for the at least one cooking device 12, 14.

With continued reference to FIG. 2, each of the one or more cooking devices may include one or more temperature detectors 84 configured to detect the temperature of the heating environment 54. For example, the cooktop 48 may incorporate a temperature detector 84 in the cooktop 48 or elsewhere (e.g., a thermal imager directed at the cooktop 48) to allow a temperature of cookware 56 that cooks the food item 18 to be monitored. In the example of temperature sensing for the oven 46, a temperature sensor may be in thermal communication with the cavity of the oven 46. It is contemplated that, in addition or in an alternative, the temperatures for the one or more cooking devices 12, 14 may be estimated or predicted based on known proportions of heating levels and timing for a particular heating cycle. For example, a maximum heat level for an induction coil of the induction cooktop 48 may have a known maximum temperature and/or rate of temperature increase. Similar estimations may be stored in the database 58 or in a memory of the first and second controllers 76, 78 to allow accurate timing predictions for the cooking environment to reach a target cooking temperature. Thus, in some examples, the temperature detectors 84 for the one or more cooking devices are omitted and the temperature profile for the cooking devices are estimated based on energy levels commanded by the first and second controllers 76, 78.

By monitoring the temperature 24 of the food item 18 and comparing the temperature 24 of the food item 18 to the temperature of the one or more cooking devices, the control circuitry 20 may selectively activate the one or more heating elements 80, 82 at specific timing 86 to limit unnecessary interruptions in the cooking process. By eliminating the unnecessary waiting time in the cooking process, as well as the food preparation process, the present system 10 may enhance a cooking experience for the user 64. Further, the controls implemented by the present system 10 may provide for enhanced energy conservation by optimizing the time for the one or more cooking devices to operate the one or more heating elements. Particular aspects related to the timing 86 and/or adjustment of heating operation will further be described below with respect to FIGS. 3 and 4.

Referring now to FIG. 3, a process 300 for utilizing the temperature data 22 of the food item 18 and heating properties of the heating environment 54 will be described with respect to exemplary pre-cooking heating options demonstrated in FIG. 4. With regard to FIG. 4, the temperatures shown may not be to scale and rather demonstrate optimization of energy and time. For example, as will be further described, the heating temperatures may be significantly greater than the food temperature 34. The process 300 includes a plurality of methods 302, 304 of operating the previously described cooking system. The process 300 includes a method 302 of controlling pre-heating for the system 10 and a method 304 of optimizing a thawing process for the food item 18. These methods 302, 304 may initiate user interaction with the user interface 62 to indicate various qualities of the food item 18, but may also or alternatively incorporate automatic features using the control circuitry 20 based on the temperature data 22 of the food item 18 and the heating profiles of the first and/or second stage cooking devices 12, 14.

At a first step 306 of the process 300, at least one quality of the food item 18 may be determined. The at least one quality may be based on manual entry via the user 64 at the user interface 62 or may be based on automatic classification and identification by a food management system 10 of the at least one storage appliance 42, 44. The at least one quality may include an identity, a weight, a shape, a volume, a size, a temperature, a frozen state, a thawed state (e.g., between 0° C. and 18°° C., or 32° F. and 64.4° F.), or any other feature related to cooking the food item 18. By way of example, a large food item may require more time to cook and/or thaw than a small food item at a common cooking temperature. Further, if the identity of the food item 18 is a meat 74, a more thorough heating cycle may be required to fully cook the food item 18. The indication may be communicated to the control circuitry 20 via the user interface 62. For example, the user 64 may manually enter the identity of the food item 18, the weight of the food item 18, or the like. In another example, the weight is communicated to the control circuitry 20 via a weight sensor (e.g., an electronic scale) on the network 40. The at least one quality may further include a source for storing the food item 18 at a food storage temperature environment. For example, the food item 18 may be stored in the refrigerator 42, the freezer 44, or in a room temperature environment.

At step 308, the process 300 includes determining whether the food is thawed or at least partially frozen. Again, the user 64 may enter this information at the user interface 62, or the information may be communicated to the control circuitry 20 via communication with other appliances on the network 40, such as the at least one storage appliance 42, 44 that may monitor the contents of the at least one storage appliance 42, 44. For example, the identity of food item 18 or other qualities of the food item 18 may be previously determined by other appliances on the network 40.

If the food item 18 is thawed, the process 300 initiates the method 302 of controlling pre-heating for the system 10. The process 300 includes determining the presence or absence of the temperature sensing device 16 in or on the food item 18 at step 310. For example, if temperature feedback is being received by the control circuitry 20 via the temperature sensing device 16, the control circuitry 20 may determine that the temperature probe 66 is in the food item 18. If there is no temperature being received from the temperature probe 66 or unexpected temperatures typically associated with no food item 18 present, the process 300 presents step 312 of requesting application of the temperature sensing device 16. For example, the user interface 62 may present a message to the user 64 to insert the temperature probe 66 in response to a signal from the control circuitry 20. In another example, the user 64 may manually enter, at the user interface 62, an indication that the temperature sensing device 16 is present at the food item 18.

At step 314, the control circuitry 20 reads the temperature data 22 of the food item 18. The control circuitry 20 further determines or estimates the timing 86 (see FIG. 4) of the first and/or second stage cooking devices 12, 14 at step 316. For example, in a passive pre-heating mode 88, the control circuitry 20 activates only the second stage cooking device 14, which may be the oven 46 or the cooktop 48, at a starting point 90a, 90b. The starting point 90a, 90b is calculated by the control circuitry 20 based on an initial temperature 92 of the food item 18 and known temperature rates for the second stage cooking device 14. The starting point 90a, 90b may be a first starting point 90a for the passive pre-heating method that may end at a first end time 32a. Alternatively, the starting point 90a, 90b may be a second starting point 90b for an active pre-heating method that ends at a second end time 32b.

By way of example, a desired set of cooking parameters for cooking a chicken breast may include the chicken breast having a target food temperature 34 of 20° C. (68° F.) and a target heating temperature 38 of 204° C. (400° F.). In this example, the chicken breast has an initial temperature 92 of 10° C. (50° F.). The control circuitry 20 may calculate a first duration 28 for the food item 18 to reach the target food temperature 34 using the passive pre-heating method (e.g., the food item 18 resting at room temperature to thaw). The system 10 may adjust the first starting point 90a of the first stage cooking device 12 to cause the first stage cooking device 12 to reach the target heating temperature 38 coinciding with the end of the first duration 28 (the first end time 32a). In an active pre-heating mode 94 at step 318, the first stage cooking device 12 is employed to warm the food item 18 to achieve the target temperature faster (i.e., at a second duration 30 shorter than the first duration 28) than allowing the food item 18 to warm at room temperature. In either mode, the control circuitry 20 may determine the duration 28, 30, the starting point 90a, 90b, a delay period 96 for starting the second stage cooking device 14, an elapsed time 36 for operating the second stage cooking device 14, and the second time 32a, 32b at which the food item 18 is ready to be cooked.

With continued reference to FIGS. 3 and 4, at step 320, the control circuitry 20 determines whether an intermediate temperature 95 of the food item 18 is reached. In some examples, the intermediate temperature 95 can be different depending on the type of food item 18, the starting temperature, and/or the type of preheat cycle (passive v. active), as demonstrated. The intermediate temperature 95 is the temperature 24 of the food item 18 calculated for the starting point 90 of the second stage cooking device 14. Accordingly, step 320 may serve as a check to confirm that the estimated starting point 90 coincides with an expected temperature for the food item 18 at that time. In some examples, this check is omitted, and the original estimation of the starting point 90 is not adjusted.

When the intermediate temperature 95 is reached and/or when the delay period 96 is terminated, the second stage cooking device 14 is activated at step 322. At step 324, the control circuitry 20 performs another check to determine whether the target food temperature 34 (e.g., the end of pre-cooking) and the target heating temperature 38 have been detected. If the target temperatures have not been reached, the control circuitry 20 may continue to operate the second stage cooking device 14 until the target temperatures are reached. Once the target temperatures are reached, the control circuitry 20 may communicate an instruction to the user interface 62 to present a message or other indication to the user 64 to begin cooking (e.g., place the food item 18 in the second stage cooking device 14) at step 326.

With continued reference to FIG. 3, the method 304 of optimizing thawing for the food item 18 may be performed if the food item 18 is found to not be thawed (e.g., at least partially frozen) at step 308. At step 328, the presence of the temperature sensing device 16 at the food item 18 is checked in a similar fashion to step 310. If not, the control circuitry 20 may initiate a de-frost operation of the oven 46 to warm the heating environment 54 and aid in thawing the food item 18. Because the temperature probe 66 is not present at step 330, the control circuitry 20 may estimate a period 100 for the food item 18 to thaw based on the at least one quality without the core temperature being directly measured at step 332. At step 334, following the period 100 of expected defrost, the user interface 62 may present a message for the user 64 to insert the temperature probe 66. For example, because the food item 18 may be solid and the probe is not present, steps 332-334 may be performed to soften the food item 18 and request insertion of the temperature probe 66 in an optimized way to limit food preparation time. In this way, the system 10 may employ the control circuitry 20 to limit unneeded delays in the cooking workflow and leave the user 64 guessing as to when the food item 18 is likely thawed. By alerting the user 64 to insert the temperature probe 66 into the food item 18 using optimized estimation for the time, the present process 300 may speed up the cooking experience.

If the temperature probe 66 is coupled with the food item 18 at step 328, the method 304 of optimizing thawing includes step 336 of operating the de-frost cycle until the food item 18 is thawed. In this case, because the temperature probe 66 is present in the food item 18, the control circuitry 20 may determine the thawed state of the food item 18 directly. Once the food item 18 is thawed, the process 300 continues to the method 302 of controlling pre-heating for the system 10 previously described.

Referring more particularly to FIG. 4, although specific temperature ranges are not illustrated, the heating temperatures of the cooking devices may be in a range greater than the range of the temperature data 22 of the food item 18 being warmed. Accordingly, a right y-axis 102 may be in the range of between 20° C. and 200° C. (68° F. and 392° F.). For example, the temperature range for the cooking devices in the warming or precooking cycles may be between room temperature (e.g., proximally 20° C.) and upwards of 200°° C., or between 68° F. and 392° F. The temperature range for the food item 18 (e.g., a left y-axis 104) may be between 0° Celsius and 100° Celsius (32° F. and 212° F.), for example. Accordingly, the temperatures may not be to scale as illustrated in FIG. 4. Further, these temperature ranges are exemplary and non-limiting.

With continued reference to FIG. 4, the control circuitry 20 may determine the duration 28, 30 for the food item 18 to reach the target food temperature 34 (e.g., the pre-cook temperature of the food item 18) in several different scenarios. For example, if the food item 18 is at a refrigeration temperature at the first time 26 and is undergoing passive thawing and passive warming at room temperature, the first duration 28 may be longer than if the food item 18 were being actively warmed via a precook cycle of the oven 46 (the second duration 30). In either example, the control circuitry 20 can calculate the delay 96/starting point 90a, 90b for activating the second stage cooking device 14 based on a difference between the duration 28, 30 and the expected elapsed time 36 for the second stage cooking device 14 to reach the target heating temperature 38. The control circuitry 20 may then delay communication of a signal to heat the second stage cooking device 14 until the starting point 90. As previously described, the starting point 90 may be determined using known timing (e.g., data stored in the database 58) for the second cooking device to reach the target heating temperature 38 at a given temperature setting. It is contemplated that the time for the second stage cooking device 14 to reach the target heating temperature 38 may be significantly less than the time for the food item 18 to reach the target food temperature 34. Accordingly, the delay 96 may correspond to the difference between the elapsed time 36 and the duration 28, 30.

With continued reference to FIG. 4, an intermediate time 106 may occur following the period elapsing during the thawing process (e.g., at the end of the de-frost cycle). The user interface 62 may communicate the message to the user 64 to insert the temperature probe 66 into the food item 18 during the intermediate time 106. During such intermediate time 106, the oven 46 may maintain the heat level provided during the de-frost cycle. The intermediate time 106 may last from the elapsing of the period 100 until the first time 26.

It is contemplated that the active adjustments to cooking cycles may be performed both prior to and during cooking cycles in addition to pre-cook cycles previously described. For example, the control circuitry 20 may be configured to calculate a period of time to cook the food item 18 in a first cooking cycle mode based on the temperature data 22 and the identity of the food item 18. Following calculation of the period of time, the control circuitry 20 may communicate a first signal to heat the at least one cooking device 12, 14 in the first cooking cycle mode for the period of time and communicate a second signal to heat the at least one cooking device 12, 14 in a second cooking cycle mode in response to the period of time elapsing. The second heat cooking cycle is different than the first cooking cycle. For example, the first and second cooking cycles may include cycles having different temperatures, a baking cycle, a convection bake cycle, a convection roast cycle, a convection crisp cycle, a broil cycle, a warming cycle, and any other cooking cycle.

By way of example, the system 10 may provide for timing and energy management during the cooking phase of the food item 15 by controlling the cooking parameters of at least one of the first and second cooking devices 12, 14 to enhance cook time. For example, the active pre-heating mode 94 involving warming the food item 15 to a temperature higher than room temperature (FIG. 4) may be applied to a first phase of a cooking process that leads into a second phase of the cooking process. In this case, the active pre-heating mode 94 is replaced with the first phase of cooking, and the timing for initiation of the second phase is controlled. The pre-cook environment temperature depicted in FIG. 4 may thus be a temperature of a first cooking environment (e.g., a cavity of an oven 46), and the cooking environment temperature depicted in FIG. 4 may be a temperature of a second cooking environment. In this example, the first cooking environment is heated to a first cooking phase temperature (e.g., 350° F. (177° C.)) under the first cooking phase parameters (e.g., convection on). As the cooking time approaches a pre-set time limit or, if the food temperature is being actively monitored, a temperature of the food item 24 approaches an intermediate temperature 95, the second cooking phase is initiated. The second cooking phase temperature may be different than the first phase cooking temperature (e.g., 400° F. (204° C.)) and/or have different cooking parameters (e.g., the second phase cooking temperature being a surface temperature of the cookware 56). By using pre-defined timing of the cooking devices 12, 14, the system 10 may temporally align the end of the first cooking phase with the second cooking phase device 14 reaching the second cooking phase temperature. Accordingly, the previous example of the active pre-heating mode 94 may be applied to the first and second cooking phases.

It is contemplated that the pre-heating control and the cooking phase control may be employed in a common food preparation process performed by the system 10. For example, the system 10 may actively track the pre-cooking cycle parameters and the cooking cycle parameters to provide the end of a first cycle to coincide with the beginning of a second cycle, the end of the second cycle to coincide with the beginning of a third cycle, etc. In this way, the system 10 may enhance timing of food preparation more broadly, with active control over pre-cooking and cooking cycles, as well as active control over other aspects of cooking cycles, such as control over a convection fan of the oven 46.

Because the amount of time for the at least one cooking device 12, 14 to reach a given temperature from an initial state may be already known or preprogrammed or otherwise stored in the database 58, the transition from the first cooking cycle to the second cooking cycle for the food item 18 may be initiated proactively. For example, the control circuitry 20 may automatically adjust the oven 46 from a convection cycle to a baking cycle after 5 minutes have elapsed in response to the food temperature 34 exceeding a pre-defined temperature threshold according to a recipe. In this way, transitions between cooking cycles may be optimized by the system 10.

In some examples, the system 10 may monitor a cooking cycle and determine an end of the cooking cycle based on the temperature data 22 and the type of food item 18 being cooked. For example, a temperature set point may be defined by the user 64 by manual entry at the user interface 62 or pre-set via set point data stored in the server 52. For example, the database 58 (FIG. 1) may store target cooking temperature set points specific to food types (e.g., chicken, beef, pasta, casserole), and the control circuitry 20 may de-energize or disable the cooking cycle when the set point is reached. In this way, the system 10 may enhance timing and energy management without causing the food item 15 to overcook or undercook.

The present system 10 may be employed in at least five ways. In a first example, the user 64 inserts the temperature probe 66 into the food item 18 that has been removed from the refrigerator 42. The system 10 monitors the internal temperature 24 of the food item 18 and, upon the internal temperature reaching a predefined threshold, the system 10 starts a preheat cycle for the oven 46. In this way, the end of the preheat cycle will coincide with the internal temperature reaching room temperature or another temperature lower than room temperature and chosen by the user 64, so that the user 64 can immediately insert the food item 18 into the oven 46 for the cooking cycle, thereby minimizing the time the food item 18 spends at room temperature or exceeds the temperature chosen by the user 64. This may limit spoilage of the food item 18 by limiting the amount of time the food item 18 spends at temperatures not suitable for storage of the food item 18. For example, if the food item 18 is meat 74, the temperatures not suitable for storage may be between 4° C. and 45° C. (40° F. and 113° F.). In addition, this process 300 also minimizes energy consumption by limiting the time the oven 46 stays at the preheated temperature before insertion of the food item 18.

In a second example, the same method as the first example is applied to a cooktop 48. In this example, the cooktop 48 is started at a pre-heat cycle to heat the cookware 56 (e.g., a pan) or a griddle in order to have the end of the preheat cycle, when the accessory (e.g., the cookware 56) reaches the predefined preheat temperature, coincide with the time when the food item 18 reaches room temperature or the user-defined temperature.

In a third example, a similar process is used to further reduce the time needed to bring the food item 18 to an initial cooking temperature (e.g., the target cooking temperature 34) by taking advantage of a controlled heating process. In this example, the oven 46 is employed as a warming chamber by setting the temperature of the cavity to be low enough to not start the cooking process, but high enough to speed up the process of bringing the food to room temperature, for example by setting the temperature to just below 50° C. (122° F.). This way, the food item 18 may be heated to room temperature or another target temperature higher than room temperature prior. Meanwhile, the system 10 would start the preheat process on the cooktop 48 in order to have the end of the preheat process coinciding with the food item 18 reaching the target food temperature 34.

In a fourth example, a similar concept is applied to food defrosting. When food item 18 is frozen, its consistency may be too hard for users 64 to insert the temperature probe 66. Therefore, it may be customary to leave the food item 18 to thaw inside the refrigerator 42 in the knowledge that the food item 18 will not be exposed to the non-storage temperature given the controlled temperature inside the refrigerator 42 itself. However, this thawing process may take a long time (e.g., several hours, a portion of a day, overnight). By taking advantage of the controlled temperature inside the oven 46, this process can be sped up. The system 10 would start thawing the food item 18 at a controlled temperature (for example at a value just below 50° C. (122° F.), as described with respect to the third example), and after an initial period for the food to be softened, the system 10 would alert the user 64 and request for the temperature probe 66 to be inserted into the food so that the thawing process can be better controlled, as previously described with respect to FIGS. 3 and 4. The duration of the initial softening period can be determined, for example, by the weight of the food item(s) 18, by inventory management systems in the refrigerator 42 or other food storage appliances, by estimations based on weight, shape, type of meat 74, by a temperature of the freezer 44, or by any other technique previously described. After the thawing process is completed, the system 10 can proceed with the processes described in the third example.

As a fifth example, users 64 could freeze the food item 18 with the probe 66 already in place (e.g., inserted to detect the core temperature) so that the thawing or defrosting process can be carried out without the initial softening phase described in the fourth example.

The system disclosed herein are further summarized in the following paragraphs and is further characterized by combinations of any and all various aspects described herein.

According to one aspect of the present disclosure, a system for controlling at least one cooking device includes a temperature sensing device that couples with a food item and control circuitry in communication with the temperature sensing device. The control circuitry is configured to receive temperature data corresponding to a temperature of the food item at a first time, determine a duration between the first time and a second time corresponding to the food item being at a target food temperature, determine an elapsed time for said at least one cooking device to generate a target heating temperature, compare the duration to the elapsed time, and communicate a first si gnal to activate said at least one cooking device based on the comparison of the duration to the elapsed time.

According to another aspect, the control circuitry is further configured to communicate the first signal when the duration is substantially equal to the elapsed time.

According to another aspect, the target food temperature corresponds to a thawed state of the food item.

According to another aspect, at least one cooking device includes at least one of a cooktop configured to heat cookware in response to the first signal and an oven configured to operate a first heating element to warm the food item in a chamber of the oven.

According to another aspect, the control circuitry is configured to receive a first indication of at least one quality of the food item, determine a period of a defrost cycle of the oven to thaw the food item in the chamber based on the at least one quality, communicate a second signal, preceding communication of the first signal, to activate the first heating element in the defrost cycle for the period, and selectively communicate a second indication to apply the temperature sensing device to the food item when the period elapses.

According to another aspect, the temperature sensing device includes a probe having a shaft engaged with the food item in a frozen state of the food item.

According to another aspect, the control circuitry is further configured to determine engagement of the probe with the food item during the defrost cycle and communicate the second indication when the probe is not engaged with the food item.

According to another aspect, the control circuitry is further configured to calculate a delay period between the elapsed time and the duration, determine a starting point for activating said at least one cooking device based on the delay period, and delay communication of the first signal until the starting point.

According to another aspect, the second time corresponds to a transition between a first cooking cycle mode and a second cooking cycle mode, wherein the second cooking cycle is different than the first cooking cycle.

According to another aspect, each of the first and second cooking cycle modes correspond to one of a baking cycle, a convection bake cycle, a convection roast cycle, a convection crisp cycle, a broil cycle, and a warming cycle.

According to another aspect of the present disclosure, a system for controlling at least one cooking device includes a temperature sensing device that couples with a food item and control circuitry in communication with the temperature sensing device. The control circuitry is configured to receive temperature data corresponding to a temperature of the food item at a first time, determine a duration between the first time and a second time corresponding to the food item being at a target food temperature, determine an elapsed time for said at least one cooking device to generate a target heating temperature, calculate a delay period between the elapsed time and the duration, determine a starting point for activating said at least one cooking device based on the delay period, delay communication of the first signal until the starting point, and communicate a first signal to activate said at least one cooking device based on the comparison of the duration to the elapsed time.

According to another aspect, a system for controlling at least one cooking device, the control circuitry is further configured to communicate the first signal when the duration is substantially equal to the elapsed time.

According to another aspect, the target food temperature corresponds to a thawed state of the food item.

According to another aspect, at least one cooking device includes at least one of a cooktop configured to heat cookware and an oven configured to operate a first heating element to warm the food item in a chamber of the oven.

According to another aspect, the control circuitry is configured to receive a first indication of at least one quality of the food item, determine a period of a defrost cycle of the oven to thaw the food item in the chamber based on the at least one quality, communicate a second signal, preceding communication of the first signal, to activate the first heating element in the defrost cycle for the period, and selectively communicate a second indication to apply the temperature sensing device to the food item when the period elapses.

According to another aspect, the temperature sensing device includes a probe having a shaft engaged with the food item in a frozen state of the food item.

According to another aspect, the control circuitry is further configured to determine engagement of the probe with the food item during the defrost cycle and communicate the second indication when the probe is not engaged with the food item.

According to another aspect, the second time corresponds to a transition between a first cooking cycle mode and a second cooking cycle mode, wherein the second cooking cycle is different than the first cooking cycle.

According to yet another aspect of the present disclosure, a system for controlling at least one cooking device includes a temperature sensing device that couples with a food item, a cooktop configured to the food item, an oven configured to operate a first heating element to warm the food item in a chamber of the oven, and control circuitry in communication with the temperature sensing device. The control circuitry is configured to receive a first indication of at least one quality of the food item, determine a period of a defrost cycle of the oven to thaw the food item in the chamber based on the at least one quality, communicate a first signal to activate the first heating element in the defrost cycle for the period, selectively communicate a second indication to apply the temperature sensing device to the food item when the period elapses, receive temperature data corresponding to a temperature of the food item at a first time, determine a duration between the first time and a second time corresponding to the food item being at a target food temperature, determine an elapsed time for said at least one cooking device to generate a target heating temperature, compare the duration to the elapsed time, and communicate a second signal to activate said at least one cooking device based on the comparison of the duration to the elapsed time.

According to another aspect, the control circuitry is further configured to determine engagement of the temperature sensing device with the food item during the defrost cycle and communicate the second indication when the temperature sensing device is not engaged with the food item.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A system for controlling at least one cooking device, the system comprising:
a temperature sensing device that couples with a food item; and
control circuitry in communication with the temperature sensing device and configured to:
receive temperature data corresponding to a temperature of the food item at a first time;
determine a duration between the first time and a second time corresponding to the food item being at a target food temperature;
determine an elapsed time for said at least one cooking device to generate a target heating temperature;
compare the duration to the elapsed time; and
communicate a first signal to activate said at least one cooking device based on the comparison of the duration to the elapsed time.

2. The system of claim 1, wherein the control circuitry is further configured to communicate the first signal when the duration is substantially equal to the elapsed time.

3. The system of claim 1, wherein the target food temperature corresponds to a thawed state of the food item.

4. The system of claim 1, wherein said at least one cooking device includes at least one of a cooktop configured to heat cookware in response to the first signal and an oven configured to operate a first heating element to warm the food item in a chamber of the oven.

5. The system of claim 4, wherein the control circuitry is configured to:
receive a first indication of at least one quality of the food item;
determine a period of a defrost cycle of the oven to thaw the food item in the chamber based on the at least one quality;
communicate a second signal, preceding communication of the first signal, to activate the first heating element in the defrost cycle for the period; and
selectively communicate a second indication to apply the temperature sensing device to the food item when the period elapses.

6. The system of claim 5, wherein the temperature sensing device includes a probe having a shaft engaged with the food item in a frozen state of the food item.

7. The system of claim 6, wherein the control circuitry is further configured to determine engagement of the probe with the food item during the defrost cycle and communicate the second indication when the probe is not engaged with the food item.

8. The system of claim 1, wherein the control circuitry is further configured to:
calculate a delay period between the elapsed time and the duration;
determine a starting point for activating said at least one cooking device based on the delay period; and
delay communication of the first signal until the starting point.

9. The system of claim 1, wherein the second time corresponds to a transition between a first cooking cycle mode and a second cooking cycle mode, wherein the second cooking cycle is different than the first cooking cycle.

10. The system of claim 9, wherein each of the first and second cooking cycle modes correspond to one of a baking cycle, a convection bake cycle, a convection roast cycle, a convection crisp cycle, a broil cycle, and a warming cycle.

11. A system for controlling at least one cooking device, the system comprising:
a temperature sensing device that couples with a food item; and
control circuitry in communication with the temperature sensing device and configured to:
receive temperature data corresponding to a temperature of the food item at a first time;
determine a duration between the first time and a second time corresponding to the food item being at a target food temperature;
determine an elapsed time for said at least one cooking device to generate a target heating temperature;
calculate a delay period between the elapsed time and the duration;
determine a starting point for activating said at least one cooking device based on the delay period;
delay communication of the first signal until the starting point; and
communicate a first signal to activate said at least one cooking device based on the comparison of the duration to the elapsed time.

12. The system of claim 11, wherein the control circuitry is further configured to communicate the first signal when the duration is substantially equal to the elapsed time.

13. The system of claim 11, wherein the target food temperature corresponds to a thawed state of the food item.

14. The system of claim 11, wherein said at least one cooking device includes at least one of a cooktop configured to heat cookware and an oven configured to operate a first heating element to warm the food item in a chamber of the oven.

15. The system of claim 14, wherein the control circuitry is configured to:
receive a first indication of at least one quality of the food item;
determine a period of a defrost cycle of the oven to thaw the food item in the chamber based on the at least one quality;
communicate a second signal, preceding communication of the first signal, to activate the first heating element in the defrost cycle for the period; and
selectively communicate a second indication to apply the temperature sensing device to the food item when the period elapses.

16. The system of claim 15, wherein the temperature sensing device includes a probe having a shaft engaged with the food item in a frozen state of the food item.

17. The system of claim 16, wherein the control circuitry is further configured to determine engagement of the probe with the food item during the defrost cycle and communicate the second indication when the probe is not engaged with the food item.

18. The system of claim 11, wherein the second time corresponds to a transition between a first cooking cycle mode and a second cooking cycle mode, wherein the second cooking cycle is different than the first cooking cycle.

19. A system for controlling at least one cooking device, the system comprising:
a temperature sensing device that couples with a food item;
a cooktop configured to the food item;
an oven configured to operate a first heating element to warm the food item in a chamber of the oven;
control circuitry in communication with the temperature sensing device and configured to:
receive a first indication of at least one quality of the food item;
determine a period of a defrost cycle of the oven to thaw the food item in the chamber based on the at least one quality;
communicate a first signal to activate the first heating element in the defrost cycle for the period;
selectively communicate a second indication to apply the temperature sensing device to the food item when the period elapses;
receive temperature data corresponding to a temperature of the food item at a first time;
determine a duration between the first time and a second time corresponding to the food item being at a target food temperature;
determine an elapsed time for said at least one cooking device to generate a target heating temperature;
compare the duration to the elapsed time; and
communicate a second signal to activate said at least one cooking device based on the comparison of the duration to the elapsed time.

20. The system of claim 19, wherein the control circuitry is further configured to determine engagement of the temperature sensing device with the food item during the defrost cycle and communicate the second indication when the temperature sensing device is not engaged with the food item.
